(19) United States
(12) Patent Application Publication
(10) Pub. No.: US 2018/0257950 A1
(43) Pub. Date: Sep. 13, 2018

(54) Salt, potable water, and energy from saline water source

(71) Applicant: William Prichard Taylor, Laguna Woods, CA (US)

(72) Inventor: William Prichard Taylor, Laguna Woods, CA (US)

(21) Appl. No.: 15/932,600

(22) Filed: Mar. 22, 2018

(51) Int. Cl. C02F 1/04; B01D 3/02; B01D 1/00; B01D 5/00; C02F 1/16; F01K 7/16

(52) U.S. Cl. CPC C02F 1/048; B01D 3/02; B01D 1/0058; C02F 2103/08; C02F 1/16; F01K 7/16; B01D 5/006

(57) ABSTRACT

This invention describes an affordable process for obtaining salable products of salt, distilled water and electrical energy from a saline water supply without harm to the environment, using components consistent with current technology and a currently available energy source. Alternatively, the water produced can be used to desalinate a saline lake instead of being marketed.

### REFERENCES

1. Perry, CIVIL ENGINEERS' HANDBOOK, McGraw-Hill Book Co., Second Edition

2. Baumeister, MARKS' MECHANICAL ENGINEERS' HANDBOOK, Sixth Edition

3. H. G. Deming, WATER, the fountain of opportunity, Oxford University Press, 1975

### BACKGROUND

Various techniques have been developed for treating saline water to obtain potable water; many of these are described in Reference 3. This invention is concerned with a process for obtaining salt, energy and distilled water from a saline source using a low cost form of energy, without harm to the environment.

### SUMMARY OF THE DISCLOSURE

The invention consists of an affordable process for obtaining valuable products of salt, distilled water, and electrical energy using a fossil fuel and the components shown in FIG. 1.

### BRIEF DESCRIPTION OF THE DRAWINGS

FIG. 1 depicts schematically (1) a process in which mineral free feedwater executes a cycle in which electrical energy is produced in a conventional steam generating unit, (2) a process in which exhaust steam which has completed the cycle transfers its energy to evaporate saline water to salt-free vapor and subsequently condensed to distilled water, and (3) a process where salt is removed in the form of slurry.

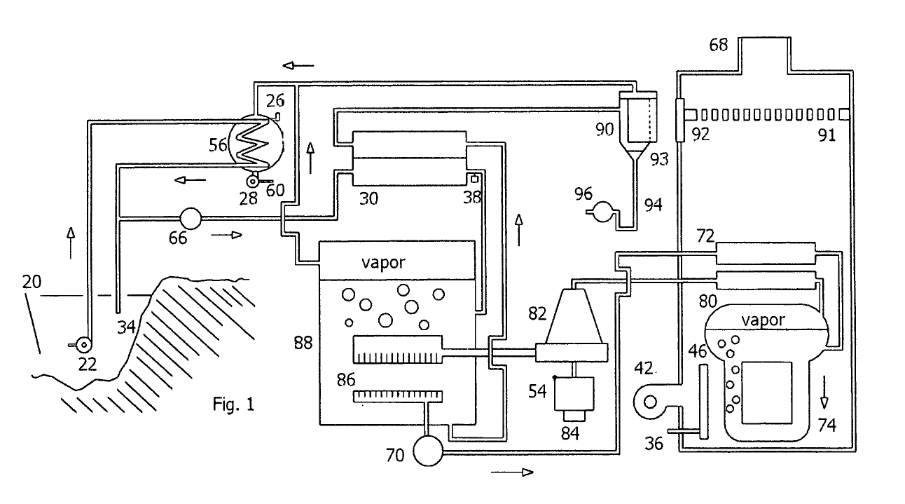

FIG. 2 depicts a thermodynamic process for the feedwater cycle, containing additional components than that of FIG. 1. In this version, steam expands initially in a high pessure turbine, is reheated in a second superheater and expands in a low pressure turbine to the exhaust pressure. This cycle is more efficient and avoids condensation in the final expansion process.

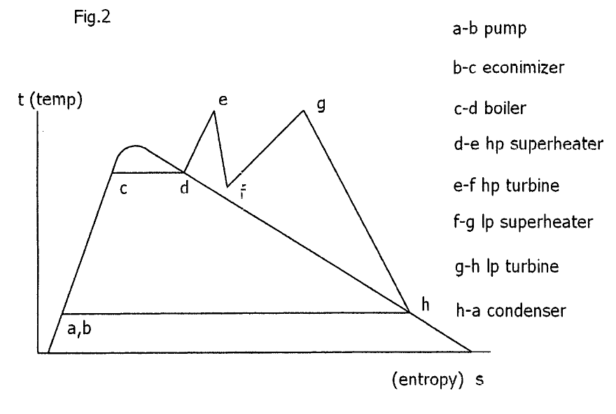

### DETAIL DESCRIPTION OF THE INVENTION

The invention consists of an an energy producing section where electrical energy is produced in a conventional steam generating unit circulating mineral free feedwater, a section where distilled water is produced, and a section where salt is extracted. The components used in sections 2 and 3 operate at partial vacuum to avoid temperatures likely to cause scale as described in Reference 3.

### ENERGY PRODUCTION

Energy is produced as feedwater executes a cycle beginning with the water condensed from the turbine, item 82 exhaust. Item 70 pump delivers water to heat exchanger 72 (this item is often described in engineering literature as an economizer) where it is evaporated in boiler 74 located in furnace 68. The heat required derives from natural gas, which enters the furnace through item 36, heated by item 46 burner which is provided combustion air by item 42 blower.

The water evaporated enters heat exchanger 80 (this item is often described as a superheater) and from there to the turbine where it expands to the exhaust pressure, completing the cycle. The turbine drives the generator, item 54 producing electrical energy accessible at receptacle 84

### DISTILLED WATER PRODUCTION

Saline water that has been pumped from the supply by item 22 submersible pump, passes through the condenser, item 56, and a portion extracted and passes through a restrictor, item 66, and then to counterflow heat exchanger 30, where it is warmed by the exiting brine (the exiting temperature, measured by temperature sensor, item 38, provides a measure of the quantity evaporated). The water then enters the thermally insulated item 88 chamber where a portion is evaporated to salt-free vapor which is conveyed to the condenser 56 and condensed to distilled water which is pumped to delivery pressure by item 28 pump for delivery at outlet 60. Non condensible gases are removed from the condenser by item 26 (an example of such a device is pictued on page 9-02 of Reference 2).

Heat required to evaporate the saline water derives from the latent heat released when the previously mentioned turbine exhaust condenses. This heat transfers to the thin, thermally conductive wall of the inner chamber and to the cooler water in the chamber where it provides the latent heat to evaporate salt-free vapor, which is then condensed to distilled water as the latent heat is transferred to the condenser coil and the saline water that circulates there; each such transfer requiring a temperature difference. The temperature inside the the inner chamber is well above that of the saline supply, though well below that which causes scale.

### SALT PRODUCTION

Table 102, page 425 of Reference 1 provides values of densities of saline solutions; solutions of higher salt content are denser and thus migrate to the bottom of the chamber. The brine exits, passes through the counterflow heat exchanger, and enters the water region of the thermally insulated brine evacuator item 90, located near the top of furnace 68.

Fins integral with plate 93 extend into the water reservoir of the brine evaporator and evaporate the moisture, leaving a slurry column. The upper surface is at condenser pressure and the salt slurry outlet, downstream of restrictor 96, is at atmospheric pressure, where the salt is collected.

The heat to evaporate the moisture is supplied from the flue gas which would otherwise exhaust to the atmosphere. A hot plate, item item 92, attached to screen 91 through which flue gas passes, radiates heat to plate 93 in the brine evaporator.

### PERFORMANCE

The distilled water produced is the total amount of evaporation in the chamber plus that evaporated in the brine evaporator, somewhat more than the amount of feedwater which circulates. This can be increased by extracting additional saline water and installing additional brine evaporators.

The energy produced by expansion of steam is not all salable since some is required by the blower, pumps, etc.

1. A process for producing energy from a conventional steam power cycle using mineral free feedwater; distlled water by evaporating saline water in a chamber, supplemented by a lesser amount from evaporating moistue from brine; and extracting salt using components based on existing technology.

2. A unique device, a brine evaporator, for extracting salt in the form of slurry using thermal energy from flue gas in furnace exhaust.
